(19) United States
(12) Patent Application Publication
(10) Pub. No.: US 2013/0176455 A1
(43) Pub. Date: Jul. 11, 2013

(54) IMAGE PROCESSING APPARATUS AND IMAGE PROCESSING METHOD

(71) Applicants: Kyoka KOBUNA, Tokyo (JP); Toshiyuki ONO, Kawasaki-shi (JP); Masahiro SEKINE, Fuchu-shi (JP); Yasunori TAGUCHI, Kawasaki-shi (JP); Nobuyuki MATSUMOTO, Inagi-shi (JP)

(72) Inventors: Kyoka KOBUNA, Tokyo (JP); Toshiyuki ONO, Kawasaki-shi (JP); Masahiro SEKINE, Fuchu-shi (JP); Yasunori TAGUCHI, Kawasaki-shi (JP); Nobuyuki MATSUMOTO, Inagi-shi (JP)

(73) Assignee: KABUSHIKI KAISHA TOSHIBA, Tokyo (JP)

(21) Appl. No.: 13/714,887

(22) Filed: Dec. 14, 2012

(30) Foreign Application Priority Data
Jan. 10, 2012 (JP) 2012-002478

(51) Int. Cl. H04N 9/73

(52) U.S. Cl. CPC H04N 9/73
USPC 348/223.1

(57) ABSTRACT

According to one embodiment, an image processing apparatus includes a calculation unit. The calculation unit calculates a reliability for each of pixel areas in such a manner that the reliability increases with increasing at least one of (1) a first evaluation value which increases with increasing planarity, in a color space, of a distribution of pixel values in each of the pixel areas, (2) a second evaluation value which increases with increasing wideness of pixel values in each of the pixel areas on an estimated plane approximating the distribution of the pixel values in each of the pixel areas in the color space, and (3) a third evaluation value which increases with decreasing distance between the estimated plane and an origin of the color space.

### CROSS-REFERENCE TO RELATED APPLICATIONS

This application is based upon and claims the benefit of priority from Japanese Patent Application No. 2012-002478, filed Jan. 10, 2012, the entire contents of which are incorporated herein by reference.

### FIELD

Embodiments described herein relate generally to a technique for estimating scattered light in an image.

### BACKGROUND

When an image of an object is captured with a camera, reflected light from the object is attenuated and scattered by the atmosphere before reaching the camera. The light reaching the camera contains a mixture of a component of the reflected light from the object and a component of scattered light that is ambient light scattered by the atmosphere. The component of the scattered light may blur the image captured with the camera. The capability of removing the component of the scattered light from the captured image (that is, making the image unblurred) allows the component of the reflected light from the object to be faithfully restored in the image with the component of the scattered light removed therefrom. Thus, the visibility of the captured image can be improved. However, the color of the scattered light in the captured image needs to be estimated in order to remove the component of the scattered light from the captured image.

### BRIEF DESCRIPTION OF THE DRAWINGS

FIG. 1 is a block diagram illustrating an image processing apparatus according to a first embodiment;

FIG. 2 is a block diagram illustrating an image processing apparatus according to a second embodiment;

FIG. 3 is a flowchart illustrating image processing by the image processing apparatus in FIG. 1;

FIG. 4 is a flowchart illustrating details of step S102 in FIG. 3;

FIG. 5 is a block diagram illustrating an image processing apparatus according to a third embodiment;

FIG. 6 is a flowchart illustrating image processing by the image processing apparatus in FIG. 5; and

FIG. 7 is a block diagram illustrating the image processing apparatus according to the third embodiment.

### DETAILED DESCRIPTION

Embodiments will be described below with reference to the drawings.

In general, according to one embodiment, an image processing apparatus includes an acquisition unit, first calculation unit, a first selection unit, and a scattered light estimation unit. The acquisition unit acquires a plurality of first pixel areas from an image. The first calculation unit calculates a first reliability for each of the plurality of first pixel areas in such a manner that the first reliability increases with increasing at least one of (1) a first evaluation value which increases with increasing planarity, in a color space, of a distribution of pixel values in each of the plurality of first pixel areas, (2) a second evaluation value which increases with increasing wideness of pixel values in each of the plurality of first pixel areas on an estimated plane approximating the distribution of the pixel values in each of the plurality of first pixel areas in the color space, and (3) a third evaluation value which increases with decreasing distance between the estimated plane and an origin of the color space. The first selection unit selects a plurality of second pixel areas from the plurality of first pixel areas based on the first reliability. The scattered light estimation unit estimates a color of scattered light in the image based on the plurality of second pixel areas.

Components which are the same as or similar to described components are denoted by the same or similar reference numerals, and duplicate descriptions are basically omitted. A color space is hereinafter assumed to be an RGB space but may be a different type of space. Furthermore, pixel values are treated as points in the color space.

### First Embodiment

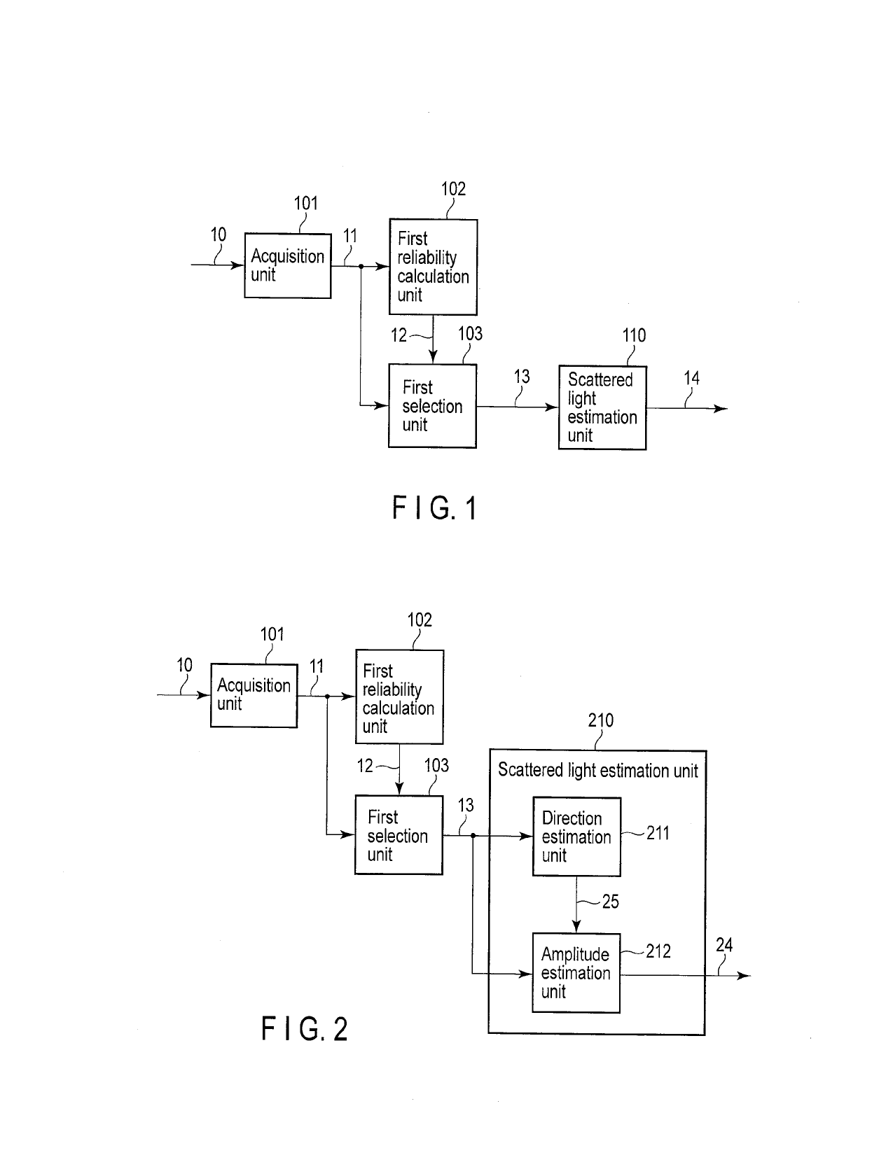

As illustrated in FIG. 1, an image processing apparatus according to a first embodiment comprises an acquisition unit 101, a first reliability calculation unit 102, a first selection unit 103, and a scattered light estimation unit 110. The image processing apparatus in FIG. 1 estimates the color 14 of scattered light in an input image 10. The color 14 of the scattered light is assumed to be uniform within the input image 10. However, the amount of scattered light mixed into each pixel is assumed to have a possibility of varying depending on the amount of particles present between an object and a view point (for example, a camera).

The acquisition unit 101 acquires a plurality of first pixel areas 11 from the input image 10. The acquisition unit 101 outputs the plurality of first pixel areas 11 to the first reliability calculation unit 102 and the first selection unit 103.

The first pixel areas 11 may be areas obtained by, for example, dividing the input image 10 into blocks. The first pixel areas 11 are hereinafter assumed to be areas obtained by dividing the input image 10 into blocks. Alternatively, the first pixel areas 11 may be areas obtained by, for example, dividing each of at least one object in the input image 10 into pieces.

The first pixel area 11 comprises a plurality of pixels. The plurality of pixels need not necessarily be spatially continuous. However, in general, the color of reflected light depends on the object. Thus, the total number of objects included in the first pixel area 11 is preferably small. For example, the acquisition unit 101 may acquire the plurality of first pixel areas 11 by reducing the input image 10 in a horizontal direction or a vertical direction and dividing the reduced input image 10 into blocks or dividing each of at least one object in the reduced input image 10 into pieces.

The first reliability calculation unit 102 inputs the plurality of first pixel areas 11 from the acquisition unit 101. The first reliability calculation unit 102 calculates a first reliability 12 for each of the plurality of first pixel areas 11. The first reliability calculation unit 102 outputs a plurality of the first reliabilities 12 to the first selection unit 103.

The first reliability 12 evaluates the reliability of each of the first pixel areas 11 in estimation of the color 14 of scattered light in the input image 10, described below. That is, the use of first pixel areas 11 with a high first reliability 12 allows the accuracy of the estimation for the scattered light to be improved. The first reliability 12 will be described below in detail.

The first selection unit 103 inputs the plurality of first pixel areas 11 from the acquisition unit 101, and inputs the plurality of first reliabilities 12 from the first reliability calculation unit 102. The first selection unit 103 selects those of the plurality of first pixel areas 11 which have high first reliabilities 12 to obtain a plurality of second pixel areas 13. The first selection unit 103 outputs the plurality of second pixel areas 13 to the scattered light estimation unit 110.

Specifically, the first selection unit 103 can obtain the plurality of second pixel areas 13 by selecting those of the plurality of first pixel areas 11 which have first reliabilities 12 equal to or greater than a first threshold value. Alternatively, the first selection unit 103 can obtain the plurality of second pixel areas 13 by selecting a predetermined number (but at least two) of first pixel areas 11 in order of decreasing first reliability 12.

The scattered light estimation unit 110 inputs the plurality of second pixel areas 13 from the first selection unit 103. The scattered light estimation unit 110 estimates the color of the scattered light in the input image 10 based on the plurality of second pixel areas 13.

Specifically, it is assumed that a given pixel area corresponds to a local uniform reflective surface of the object and that in the given pixel area, a pixel value is varied only by differences, among the pixels, in the brightness of reflected light from the object and the amount of scattered light mixed in the reflected light. According to this assumption, any pixel value in a given pixel area is determined by alpha blending of the color of the reflected light from the object and the color 14 of the scattered light. That is, any pixel value in a given pixel area occupies a point on an ideal plane formed by the linear sum of the vector of the color of the reflected light and the vector of the color 14 of the scattered light in the color space. As described above, the color 14 of the scattered light is uniform within the input image 10. Hence, the vector of the color 14 of the scattered light is indicated by the line of intersection between different ideal planes which are formed by the linear sums of the vector of the color 14 of the scattered light and each of the vectors of the different colors reflected light in different pixel areas. Based on this assumption, the scattered light estimation unit 110 can estimate the color 14 of the scattered light.

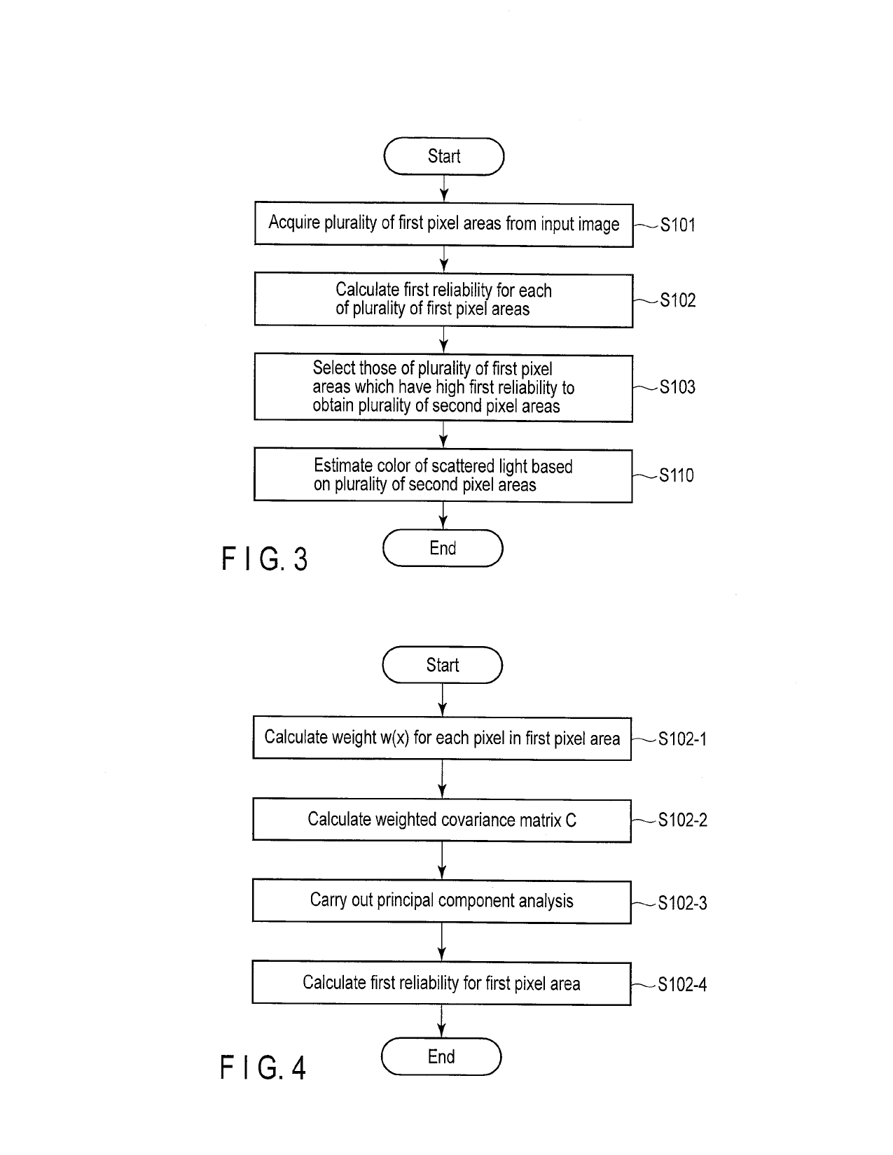

An example of image processing carried out by the image processing apparatus in FIG. 1 will be described with reference to FIG. 3. When the image processing in FIG. 3 starts, step S101 is carried out.

In step S101, the acquisition unit 101 acquires the plurality of first pixel areas 11 from the input image 10. The first reliability calculation unit 102 calculates the first reliability 12 for each of the plurality of first pixel areas 11 acquired in step S101 (step S102).

The first selection unit 103 selects those of the plurality of first pixel areas 11 acquired in step S101 which have been calculated in step S102 to have high first reliabilities 12. The first selection unit 103 thus obtains a plurality of second pixel areas 13 (step S103).

The scattered light estimation unit 110 estimates the color 14 of the scattered light based on the plurality of second pixel areas 13 selected in step S103 (step S104). When step S104 is completed, the image processing in FIG. 3 ends.

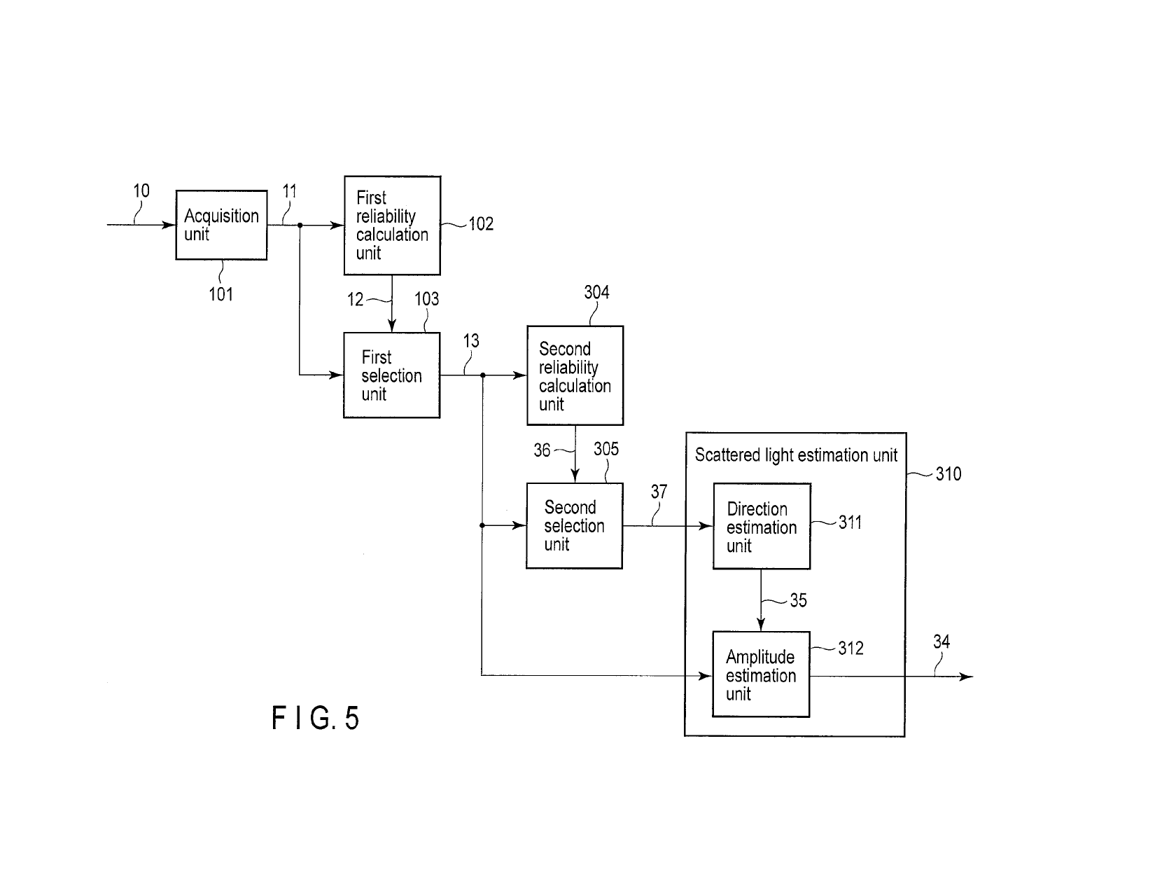

Here, step S102 in FIG. 3 is implemented by carrying out, for example, a first reliability calculation process shown in FIG. 4 on each of the plurality of first pixel areas 11. When the first reliability calculation process in FIG. 4 starts, step S102-1 is carried out.

In step S102-1, the first reliability calculation unit 102 calculates weight w(x) of each pixel in the first pixel area 11. Here, x denotes a position vector identifying each pixel and which can be expressed by, for example, the coordinates of the pixel in the input image 10. Furthermore, the pixel value of a pixel x can be expressed by I(x)=(I₁(x), I₂(x), I₃(x))^{t}. I(x) denotes a three-dimensional vector having the RGB value of pixel x as an element. Weight w(x) is calculated to increase with decreasing color difference d(x_{C}, x) between a pixel of interest x_{C} described below and pixel x.

Pixel of interest x_{C} is any one of the plurality of pixels in the first pixel area 11. Pixel of interest x_{C} may be, for example, a pixel occupying a particular position in the first pixel area 11 (for example, a central position of the first pixel area 11) or a pixel with a pixel value closest to an average pixel value within the first pixel area 11.

Alternatively, pixel of interest x_{C} may be optionally selected from the first pixel area 11 without any basis on the position or the pixel value. Pixel of interest x_{C} is hereinafter defined to occupy the central position in the first pixel area 11.

The color difference d(x_{C}, x′) between pixel of interest x_{C} and another peripheral pixel x′ can be derived by Expression (1) shown below. The color difference d(x_{C}, x_{C}) between pixel of interest x_{C} and pixel of interest x_{C} can be considered to be zero.

$$d ( {x}_{c} , {x}^{′} ) = min \{ \vert θ ( {x}_{c} ) - θ ( {x}^{′} ) \vert , \\ 2 π - \vert θ ( {x}_{c} ) - θ ( {x}^{′} ) \vert \} \\ θ ( {x}_{c} ) = {tan}^{- 1} \{ \frac{U ( {x}_{c} )}{V ( {x}_{c} )} \} \\ θ ( {x}^{′} ) = {tan}^{- 1} \{ \frac{U ( {x}^{′} )}{V ( {x}^{′} )} \} \qquad ( 1 )$$

In Expression (1), U(x) denotes a U component of a pixel value I(x) in a YUV color space, and V(x) denotes a V component of pixel value I(x) in the YUV color space. As is apparent from Expression (1), the value of the color difference d(x_{C}, x′) decreases with increasing the similarity between the color of pixel of interest x_{C} and the color of peripheral pixel x′.

Weight w(x) is calculated to increase with decreasing color difference d(x_{C}, x) between pixel of interest x_{C} and pixel x.

$$w ( x ) = exp ( \frac{- {d ( {x}_{c} , x )}^{2}}{{σ}_{θ}^{2}} ) \qquad ( 2 )$$

In Expression (2), σ_{θ} is a constant. Weight w(x) calculated by Expression (2) is at least 0 and at most 1.

The first reliability calculation unit 102 uses weight w(x) determined in step S102-1 to calculate a covariance matrix C for the distribution of pixel values in the first pixel area 11 (step S102-2). The first reliability calculation unit 102 can calculate an element Cᵢⱼ in the ith row and the jth column of the covariance matrix C by:

$${c}_{ij} = \frac{1}{W} {\sum }_{n = 1}^{N} {x}_{ni} {T}_{{X}_{nj} w ( {x}_{n} )} \\ {x}_{np} = {x}_{np} - \overline{{x}_{p}} \\ \overline{{x}_{p}} = \frac{1}{N} {\sum }_{n = 1}^{N} {x}_{np} \\ W = {\sum }_{n ∈ R} w ( {x}_{n} ) \qquad ( 3 )$$

As described above, the RGB space is assumed as a color space. Thus, in Expression (3), i, j=1, 2, 3. R denotes the first pixel area 11. n denotes an index which identifies the individual pixels in the first pixel area 11 (=R) and which can take one of consecutive natural numbers from 1 to N. That is, N denotes the total number of pixels in the first pixel area 11 (=R). xₙ denotes the position vector of a pixel identified by n. xₙₚ denotes the pth element of a pixel value I(xₙ). p=1, 2, 3. Expression (3) indicates that contribution from pixel to the covariance matrix C increases with increasing the similarity in color of the pixel to pixel of interest x_{C} and that the covariance matrix C is thus effective for approximating a uniform reflective surface. Specifically, the first pixel area 11 may be mixed with colors, noise, and the like which are different from those from the uniform reflective surface, but the adverse effect of this mixture is reduced by the above-described weighting.

The first reliability calculation unit 102 carries out principal component analysis on the covariance matrix C calculated in step S102-2 (step S102-3). Specifically, the first reliability calculation unit 102 calculates an eigenvector and an eigenvalue for the first principal component of the covariance matrix C, an eigenvector and an eigenvalue for the second principal component, and an eigenvector and an eigenvalue for the third principal component.

Based on the results of the principal component analysis carried out in step S102-3, the first reliability calculation unit 102 calculates the first reliability 12 for the first pixel area 11 (step S102-4). When step S102-4 is completed, the first reliability calculation process on the first pixel area 11 ends. The first reliability 12 will be described below in detail.

It is assumed that the first pixel area 11 corresponds to the local uniform reflective surface of the object and that in the first pixel area 11, the pixel value is varied only by a difference, among the pixels, in the brightness of reflected light from the object and the amount of scattered light mixed in the reflected light. If this assumption holds true, any pixel value in the first pixel area 11 occupies a point on an ideal plane formed by the linear sum of the vector of the color of the reflected light and the vector of the color 14 of the scattered light in the color space. Further, all the pixel values in the first pixel area 11 are distributed on the ideal plane. In other words, in theory, estimating the plane with the pixel values in the first pixel area 11 distributed thereon allows the ideal plane for the first pixel area 11 to be indirectly derived as an estimated plane for the first pixel area 11. The estimated plane for the first pixel area 11 (=R) is formed by the linear sum of eigenvector v^{R}₁ of the first principal component and eigenvector v^{R}₂ of the second principal component; both eigenvectors are included in the results of the principal component analysis in step S102-3.

However, if the first pixel area 11 fails to correspond to the local uniform reflective surface of the object or noise is added to the pixel value, the pixel value is varied by a factor that is inconsistent with the above-described assumption. Hence, the pixel values in the first pixel area 11 are not necessarily distributed on the ideal plane. The estimated plane for the first pixel area 11 does not necessarily match the ideal plane for the first pixel area 11.

Here, the color 14 of the scattered light is theoretically estimated based on different ideal planes but actually needs to be estimated based on different estimated planes. That is, an estimated plane significantly different from the ideal plane (that is, an inaccurate estimated plane) may reduce the accuracy of estimation of the color 14 of the scattered light. Thus, in the estimation of the color 14 of the scattered light, calculating the reliability for the first pixel area 11 (the accuracy of the estimated plane for the first pixel area 11) contributes to improving the accuracy of estimation of the color 14 of the scattered light.

The first reliability 12 is calculated mainly based on one or two or all of the three evaluation criteria described below.

The first evaluation criterion is how planar the distribution of the pixel values in the first pixel area 11 is in the color space. The determined reliability of the first pixel area 11 increases with increasing the planarity, in the color space, of the distribution of the pixel values in the first pixel area 11 (in other words, the closeness of the pixel values in the first pixel area 11 to any plane in the color space). An evaluation value for the first evaluation criterion is denoted by e₀. A greater evaluation value e₀ means higher planarity of the distribution of the pixel values in the first pixel area 11. e₀ may also be referred to as the planarity. The evaluation value e₀ may be calculated based on the eigenvalue of the third principal component included in the results of the principal component analysis in step S102-3.

A second evaluation criterion is how widely the pixel values in the first pixel area 11 are distributed on the estimated plane for the first pixel area 11. The determined reliability of the first pixel area 11 increases with increasing the wideness of the distribution of the pixel values in the first pixel area 11 on the estimated plane for the first pixel area 11. An evaluation value for the second evaluation criterion is denoted by e₁. A greater evaluation value e₁ means a wider distribution of the pixel values in the first pixel area 11 on the estimated plane for the first pixel area 11. e₁ may also be referred to as the degree of plane dispersion. The evaluation value e₁ may be calculated based on the eigenvalue of the first principal component and the eigenvalue of the second principal component included in the results of the principal component analysis in step S102-3. For example, the evaluation value e₁ may be calculated to increase with increasing the sum of the eigenvalue of the first principal component and the eigenvalue of the second principal component. Alternatively, the evaluation value e₁ may be calculated exclusively based on the eigenvalue of the second principal component.

A third evaluation criterion is how far the estimated plane for the first pixel area 11 lies from the origin of the color space. Both the vector of the color 14 of the scattered light and the vector of the color of the reflected light in the first pixel area 11 pass through the origin of the color space, and thus the ideal plane formed by the vectors also passes through the origin. Hence, the determined reliability of the first pixel area 11 increases with decreasing distance between the estimated plane for the first pixel area 11 and the origin of the color space. An evaluation value for the third evaluation criterion is denoted by e₂. A greater evaluation value e₂ means a shorter distance between the estimated plane for the first pixel area 11 and the origin of the color space.

The first reliability calculation unit 102 calculates the first reliability 12 (=E1(R)) for the first pixel area 11 (=R) by:

E1(R)=w₀e₀+w₁e₁+w₂e₂ (4)

In Expression (4), w₀, w₁, and w₂ denote weights that can take a value of at least 0 and at most 1. However, at least one of weights w₀, w₁, and w₂ takes a value of greater than 0. In other words, the first reliability calculation unit 102 calculates the first reliability 12 (=E1(R)) for the first pixel area 11 (=R) so that the first reliability 12 increases with increasing at least one of the evaluation values e₀, e₁, and e₂. Besides Expression (4), for example, the product of at least two of the evaluation values e₀, e₁, and e₂ may be used to calculate the first reliability 12 (=E1(R)).

As described above, the first selection unit 103 selects those of the plurality of first pixel areas 11 which have high first reliabilities 12 to obtain the plurality of second pixel areas 13. That is, those of the plurality of first pixel areas 11 which are determined to be reliable in the estimation of the color 14 of the scattered light are selected as the plurality of second pixel areas 13. The scattered light estimation unit 110 utilizes the plurality of second pixel areas 13 and can thus accurately estimate the color 14 of the scattered light.

As described above, the image processing apparatus according to the first embodiment estimates the color of the scattered light based on the assumption that the pixel values in the local area of the input image are distributed on the ideal plane formed by the linear sum of the vector of the color of the reflected light in the local area and the vector of the color of the scattered light. Then, the image processing apparatus evaluates the first reliability of each of the plurality of first pixel areas in the estimation of the color of the scattered light, based on at least one of the first evaluation criterion, the second evaluation criterion, and the third evaluation criterion. The image processing apparatus selects first pixel areas with high first reliabilities and then estimates the color of the scattered light. Thus, the image processing apparatus can improve the accuracy of estimation of the color of the scattered light in the input image.

### Second Embodiment

A second embodiment specifically illustrates an example of a technique for estimating the color 14 of scattered light based on a plurality of second pixel areas 13. As shown in FIG. 2, the image processing apparatus according to the present embodiment comprises an acquisition unit 101, a first reliability calculation unit 102, a first selection unit 103, and a scattered light estimation unit 210. The image processing apparatus in FIG. 2 estimates the color 24 of scattered light in an input image 10.

The scattered light estimation unit 210 comprises a direction estimation unit 211 and an amplitude estimation unit 212.

The direction estimation unit 211 inputs the plurality of second pixel areas 13 from the first selection unit 103. The direction estimation unit 211 estimates the direction 25 of the scattered light vector in the RGB space or other color space based on the plurality of second pixel areas 13. The direction estimation unit 211 outputs the estimated direction 25 of the scattered light vector to the amplitude estimation unit 212.

To allow the direction 25 of the scattered light vector to be estimated, an estimated plane needs to be derived for the plurality of second pixel areas 13. Hence, as in the case of the above-described first reliability calculation unit 102, the following need to be carried out for each of the plurality of second pixel areas 13: a weight w(x) is calculated (as is the case with step S102-1), a weighted covariance matrix C is calculated (as is the case with step S102-2), and principal component analysis is carried out (step S102-3). The direction estimation unit 211 may carry out the above-described processing independently of the first reliability calculation unit 102 or reutilize the results of the processing by first reliability calculation unit 102.

The estimated plane for the second pixel area 13 (=R) is formed by the linear sum of eigenvector v^{R}₁ of the first principal component of the weighted covariance matrix C for the second pixel area 13 (=R) and eigenvector v^{R}₂ of the second principal component of the weighted covariance matrix C for the second pixel area 13 (=R). Ideally, each of the estimated planes for the plurality of second pixel areas 13 contains the vector of the color 24 of the scattered light. That is, the line of intersection between the estimated planes for different second pixel areas 13 indicates the vector of the color 24 of the scattered light.

Thus, the direction estimation unit 211 can estimate a vector A_{d} indicative of the direction 25 of the scattered light vector by:

$${max}_{{A}_{d}} {\sum }_{R} ( {〈 {A}_{d} , {v}_{1}^{R} 〉}^{2} + {〈 {A}_{d} , {v}_{2}^{R} 〉}^{2} ) \\ where \\ ‖ {A}_{d} ‖ = 1 \qquad ( 5 )$$

Expression (5) is indicative of vector A_{d} having the largest total amplitude when projected on each of the estimated planes for the plurality of second pixel areas 13. In actuality, the direction estimation unit 211 derives vector A_{d} in Expression (5) by calculating the eigenvector of the first principal component of a 3×3 matrix expressed by:

Σ_{R}(v₁^{R}(v₁^{R})^{t}+v₂^{R}(v₂^{R})^{t}) (6)

Alternatively, the direction estimation unit 211 may estimate vector A_{d} indicative of the direction 25 of the scattered light vector by:

$${max}_{{A}_{d}} {\sum }_{R} ( {〈 {A}_{d} , {v}_{1}^{R} 〉}^{2} + {〈 {A}_{d} , {v}_{2}^{R} 〉}^{2} ) * f ( E 1 ( R ) ) where ‖ {A}_{d} ‖ = 1 \qquad ( 7 )$$

In Expression (7), f(E1(R)) denotes a weight corresponding to the first reliability 12 (=E1(R)) of the second pixel area 13 (=R). Weight f(E1(R)) is defined to increase with increasing the first reliability 12 (=E1(R)). Expression (7) is indicative of vector A_{d} with the maximum weighted sum of amplitudes thereof as projected on each of the estimated planes for the plurality of second pixel areas 13. In actuality, the direction estimation unit 211 derives vector A_{d} in Expression (7) by calculating the eigenvector of the first principal component of a 3×3 matrix expressed by:

Σ_{R}{(v₁^{R}(v₁^{R})^{t}+v₂^{R}(v₂^{R})^{t}*f(E1(R))} (8)

Alternatively, the direction estimation unit 211 may estimate a predetermined direction in the color space to be the direction 25 of the scattered light vector without any basis on the calculations in Expressions (5) to (8). In this case, the direction estimation unit 211 need not input the plurality of second pixel areas 13. For example, if the input image 13 is captured in the daytime, the color 24 of the scattered light can be expected to be close to white (an achromatic color other than black) as a result of Mie scattering. Hence, the direction estimation unit 211 may estimate a vector having an amplitude of 1 and acting in the same direction as that of a vector (1, 1, 1) in the RGB space to be the direction 25 of the scattered light vector. Furthermore, if the input image 10 is of a sunset, the scattered light can be expected to be close to red. Hence, the direction estimation unit 211 may estimate a vector (1, 0, 0) in the RGB space to be the direction 25 of the scattered light vector. Additionally, if the input image 10 has been captured under water, the scattered light can be expected to be close to blue. Thus, the direction estimation unit 211 may estimate a vector (0, 0, 1) in the RGB space to be the direction 25 of the scattered light vector.

The amplitude estimation unit 212 inputs the plurality of pixel areas 13 from the first selection unit 103 and inputs the direction 25 of the scattered light vector from the direction estimation unit 211. The amplitude estimation unit 212 estimates the amplitude of the color of the scattered light based on the direction 25 of the scattered light vector and the plurality of second pixel areas 13. The amplitude estimation unit 212 multiplies the direction 25 of the scattered light vector by the estimated amplitude of the color of the scattered light to obtain the color 24 of the scattered light. The amplitude estimation unit 212 outputs the color 24 of the scattered light.

As described above, each of the plurality of second pixel areas 13 is assumed to correspond to a uniform reflective surface. Hence, in any second pixel area 13, any pixel value I(x) can be expressed by Expression (9) shown below. The vector of the color of reflected light in this second pixel area 13 is denoted by B, and the vector of the color 24 of scattered light in this second pixel area 13 is denoted by A.

Furthermore, when the amplitude of the color of the scattered light is denoted by α, A=αA_{d}.

I(x)=t(x)l(x)B+(1−t(x))A (9)

In Expression (9), t(x) denotes a parameter (at least 0 and at most 1) which affects the amount of scattered light mixed in a pixel x. l(x) denotes a parameter (at least 0 and at most 1) which affects change of the brightness of the reflected light in pixel x. Parameters l(x) and t(x) may be considered to be independent of each other. Hence, the amplitude estimation unit 212 can estimate the amplitude of the color of the scattered light by deriving α that minimizes the absolute value of a covariance C (l(x), t(x)) of parameters l(x) and t(x).

For example, the amplitude estimation unit 212 can search for the minimum value of the covariance C (l(x), t(x)) by varying a over a specific range for any second pixel area 13 (=R). Specifically, the amplitude estimation unit 212 sets a to an initial value α₁ and also sets vector A of the color of the scattered light to α₁A_{d}. Based on vector A=α₁A_{d} of the color of the scattered light, the amplitude estimation unit 212 uses independent component analysis (ICA) to derive minimum value C₁ of the covariance C(l(x), t(x)). The amplitude estimation unit 212 can similarly derive minimum values C₂, C₃, . . . of the covariance C(l(x), t(x)) for a₂, a₃, . . . . Then, the amplitude estimation unit 212 can search for the minimum C₁ of values C₁, C₂, C₃, . . . and estimate the corresponding α₁ to be the amplitude α_{R} of the color of the scattered light based on the second pixel area 13 (=R). This results in a vector A_{R}=α_{R}A_{d} for the color 24 of the scattered light based on the second pixel area 13 (=R). The estimated amplitude of the color of the scattered light (=α_{R}) may vary depending on the second pixel area 13. Since the color 24 of the scattered light is assumed to be uniform within the input image 10, the amplitude estimation unit 212 may, for example, estimate vector A₁ of the color 24 of the scattered light in the input image 10 by:

$$\begin{matrix}‖ {A}_{i} ‖ = \frac{1}{{N}_{R}} {\sum }_{R} ‖ {A}_{R} ‖ \\ = \frac{1}{{N}_{R}} {\sum }_{R} {α}_{R}\end{matrix} \qquad ( 10 )$$

In Expression (10), N_{R} denotes the total number of pixel areas (for example, the second pixel areas 13) utilized to estimate the amplitude of the color of the scattered light. According to Expression (10), the amplitude estimation unit 212 estimates the arithmetic mean of the amplitude α_{R} of the color of the scattered light estimated for each of the second pixel areas 13 to be the amplitude of vector A₁ of the color 24 of the scattered light in the input image 10.

Alternatively, the amplitude estimation unit 212 may estimate the amplitude of vector A₁ of the color 24 of the scattered light in the input image 10, for example, by:

$$\begin{matrix}‖ {A}_{i} ‖ = \frac{1}{{F}_{R}} {\sum }_{R} ‖ {A}_{R} ‖ * {f}_{2} ( E 1 ( R ) ) \\ = \frac{1}{{F}_{R}} {\sum }_{R} {α}_{R} * {f}_{2} ( E 1 ( R ) )\end{matrix} \\ {F}_{R} = {\sum }_{R} {f}_{2} ( E 1 ( R ) ) \qquad ( 11 )$$

In Expression (11), f₂(E1(R)) denotes a weight corresponding to the first reliability 12 (=E1(R)) of the second pixel area 13 (=R). Weight f₂(E1(R)) is defined to increase with increasing the first reliability 12 (=E1(R)). According to Expression (11), the amplitude estimation unit 212 estimates the weighted mean of the amplitude α_{R} of the color of the scattered light estimated for each of the second pixel areas 13 to be the amplitude of vector A₁ of the color 24 of the scattered light in the input image 10.

Alternatively, the amplitude estimation unit 212 may estimate the amplitude of vector A₁ of the color 24 of the scattered light in the input image 10, for example, by:

$$\begin{matrix}‖ {A}_{i} ‖ = max ( ‖ {A}_{1} ‖ , … , ‖ {A}_{{N}_{R}} ‖ ) \\ = max ( {α}_{1} , … , {α}_{{N}_{R}} )\end{matrix} \qquad ( 12 )$$

According to Expression (12), the amplitude estimation unit 212 estimates the maximum value of the amplitude α_{R} of the color of the scattered light estimated for each of the second pixel areas 13 to be the amplitude of vector A₁ of the color 24 of the scattered light in the input image 10.

As described above, the image processing apparatus according to the second embodiment derives the color of the scattered light by estimating the direction and amplitude of the color of the scattered light based on the plurality of second pixel areas described in the first embodiment. Thus, the image processing apparatus enables an increase in the accuracy of estimation of the color of the scattered light in the input image.

### Third Embodiment

As illustrated in FIG. 5, an image processing apparatus according to a third embodiment comprises an acquisition unit 101, a first reliability calculation unit 102, a first selection unit 103, a second reliability calculation unit 304, a second selection unit 305, and a scattered light estimation unit 310. The image processing apparatus in FIG. 5 estimates the color 34 of scattered light in an input image 10.

The second reliability calculation unit 304 inputs a plurality of second pixel areas 13 from the first selection unit 103. The second reliability calculation unit 304 calculates a second reliability 36 for each of at least one combination including at least two of the plurality of second pixel areas 13. Specifically, the second reliability calculation unit 304 calculates the second reliability 36 so that the second reliability 36 increases with increasing the sum of the levels of orthogonality indicative of the angular orthogonality between at least one pair of estimated planes approximating the distribution of pixel values in the second pixel areas 13 included in the combination (the sum may also referred to as the level of independence). The second reliability will be described below in detail. The second reliability calculation unit 304 outputs at least one second reliability 36 to the second selection unit 305. However, as described below, the second reliability calculation unit 304 does not necessarily calculate the second reliability 36 for all the combinations.

The second selection unit 305 inputs the plurality of second pixel areas 13 from the first selection unit 103, and also inputs at least one second reliability 36 from the second reliability calculation unit 304. The second selection unit 305 selects one combination with a high second reliability 36 from at least one combination including at least two second pixel areas 13 to obtain a plurality of third pixel areas 37. Specifically, the second selection unit 305 can obtain the plurality of third pixel areas 37 by selecting one combination with the highest second reliability 36 from the at least one combination. The second selection unit 305 outputs the plurality of third pixel areas 37 to the scattered light estimation unit 310.

The scattered light estimation unit 310 comprises a direction estimation unit 311 and an amplitude estimation unit 312.

The direction estimation unit 311 inputs the plurality of third pixel areas 37 from the second select unit 305. The direction estimation unit 311 estimates the direction 35 of scattered light vector based on the plurality of third pixel areas 37. The direction estimation unit 311 outputs the estimated direction 35 of the scattered light vector to the amplitude estimation unit 312. The direction estimation unit 311 carries out the same processing as or processing similar to that of the direction estimation unit 211 on the plurality of third pixel areas 37 to estimate the direction 35 of the scattered light vector.

The amplitude estimation unit 312 inputs the plurality of second pixel areas 13 from the first selection unit 103, and also inputs the direction 35 of the scattered light vector from the direction estimation unit 311. The amplitude estimation unit 312 estimates the amplitude of the color of the scattered light based on the direction 35 of the scattered light vector and the plurality of second pixel areas 13. The amplitude estimation unit 312 multiplies the direction 35 of the scattered light vector by the estimated amplitude of the color of the scattered light to obtain the color 34 of the scattered light. The amplitude estimation unit 312 outputs the color 34 of the scattered light. The amplitude estimation unit 312 carries out the same processing as or processing similar to that of the amplitude estimation unit 212 on the direction 35 of the scattered light vector and the plurality of second pixel areas 13 to estimate the amplitude of the color of the scattered light.

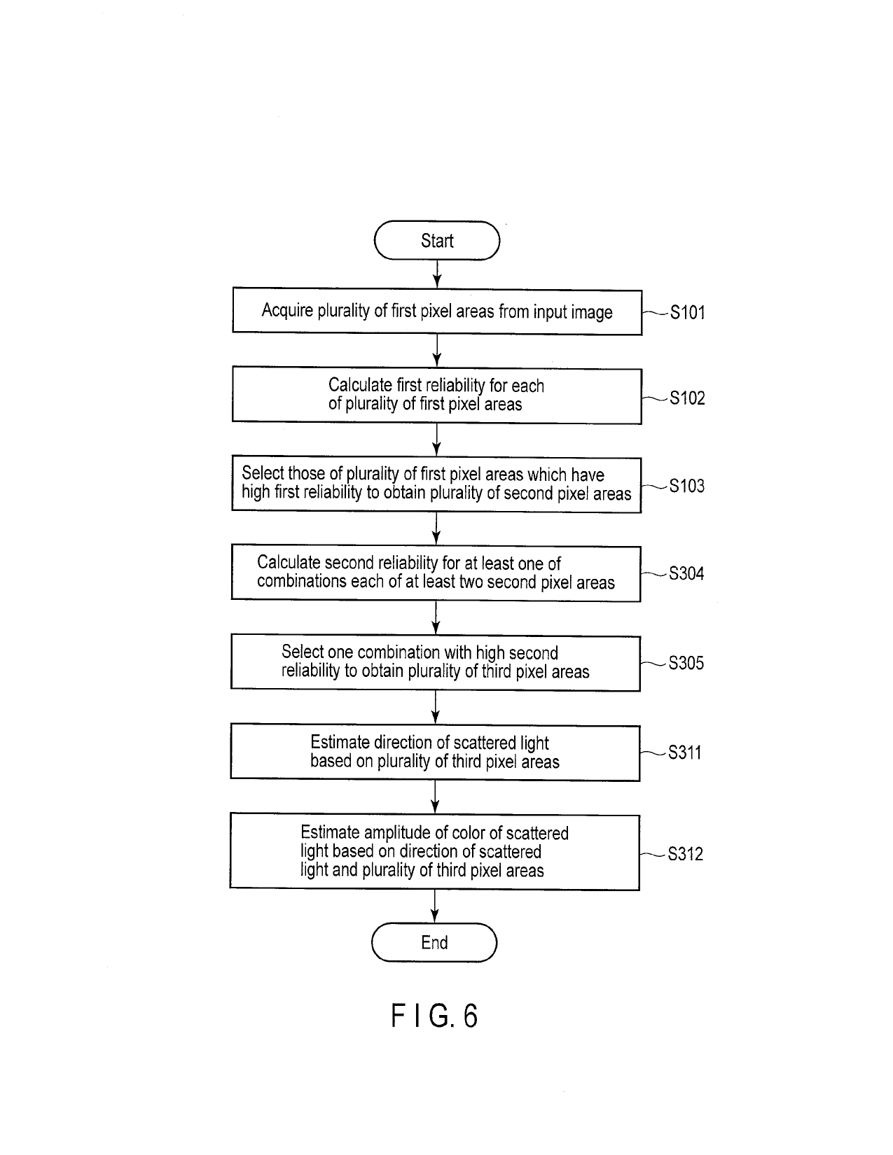

An example of image processing carried out by the image processing apparatus in FIG. 5 will be described below with reference to FIG. 6. When the image processing in FIG. 6 starts, step S101 is carried out. Steps S101, S102, and S103 in FIG. 6 are the same as those in FIG. 3 and will thus not be described in detail.

The second reliability calculation unit 304 calculates the second reliability 36 for each of the at least one combination including the at least two of the plurality of second pixel areas 13 selected in step S103 (step S304). The second selection unit 305 obtains the plurality of third pixel areas 37 by selecting one of the combinations with a high second reliability 36 calculated in step S304 (step S305).

The direction estimation unit 311 estimates the direction 35 of the scattered light vector based on the plurality of third pixel areas 37 selected in step S305 (step S311). The amplitude estimation unit 312 estimates the amplitude of the color of the scattered light based on the plurality of second pixel areas 13 selected in step S103 and the direction 35 of the scattered light vector estimated in step S311. The amplitude estimation unit 312 then multiplies the direction 35 of the scattered light vector by the estimated amplitude of the color of the scattered light to obtain the color 34 of the scattered light (step S312). When step S312 is completed, the image processing in FIG. 6 ends.

The second reliability 36 will be described below in detail. Typically, the second reliability 36 of any combination is the sum of the levels of orthogonality between at least one pair of estimated planes approximating the distribution of pixel values in the second pixel areas 13 included in the combination (the sum may also referred to as the level of independence).

The total number of combinations including at least two of the plurality of second pixel areas 13 is generally enormous. Consequently, in actuality, calculating the second reliability 36 for all the combinations may be difficult. Thus, preferably, the second reliability calculation unit 304 enables the appropriate combination to be selected as the plurality of third pixel areas 37 with the amount of calculation of the second reliability 36 reduced, by utilizing, for example, a greedy algorithm.

The second reliability calculation unit 304 calculates the second reliability 36 for each of at least one combination including two second pixel areas 13 (=Rᵢ, Rⱼ), for example, in accordance with Expression (13) shown below, to search for a combination the maximizes the second reliability 36.

$${max}_{{R}_{i} , {R}_{j} ∈ {{W}_{1}}_{( i \neq j )}} \{ 1 - {〈 {v}_{3}^{{R}_{i}} , {v}_{3}^{{R}_{j}} 〉}^{2} \} \qquad ( 13 )$$

In Expression (13), v^{Ri}₃ and v^{Rj}₃ denote the eigenvectors of the third principal components of weighted covariance matrices C of the distributions of pixel values in the second pixel areas 13 (=Rᵢ, Rⱼ). The eigenvectors of the third principal components correspond to normals of estimated planes for the second pixel areas 13. W₁ denotes a set of the plurality of the second pixel areas 13. Furthermore, in Expression (13), one of the second pixel areas 13 (=Rᵢ or Rⱼ) may be fixed to one of the second pixel areas 13 which has the highest reliability 12. This technique enables a reduction in the amount of calculation in Expression (13).

Subsequently, the second reliability calculation unit 304 calculates an increment in the second reliability 36 obtained when n (n≧2) second pixel areas that maximize the second reliability 36 are combined with an additional second pixel area 13, and further searches for a combination that maximizes the increment in the second reliability 36. That is, the second reliability calculation unit 304 can increase the total number of second pixel areas 13 included in the combination to two, three, . . . while narrowing down calculation targets for the second reliability 36.

$${max}_{{R}_{k} ( {R}_{k} ∉ {W}_{2} )} {\sum }_{{R}_{i} ∈ {W}_{2}} \{ 1 - {〈 {v}_{3}^{{R}_{i}} , {v}_{3}^{{R}_{k}} 〉}^{2} \} \qquad ( 14 )$$

In Expression (14), W₂ denotes a set of n second pixel areas 13 searched for by the present algorithm. That is, the number of elements of the set W₂ increases sequentially to two, three, . . . .

The second reliability calculation unit 304 may end the calculation of the second reliability 36, for example, when n reaches a predetermined number or when the second reliability 36 becomes equal to or greater than a second threshold value. Alternatively, the second reliability calculation unit 304 may end the calculation of the second reliability 36 when the change in the second reliability 36 decreases below a predetermined specific value.

As described above, the image processing apparatus according to the third embodiment selects a plurality of third pixel areas by selecting those of at least one combination including at least two second pixel areas which have a large sum of the levels of orthogonality between estimated planes. The image processing apparatus then estimates the direction of the scattered light vector based on the plurality of third pixel areas. Thus, the image processing apparatus according to the third embodiment enables an increase in the accuracy of estimation of the direction of the scattered light vector.

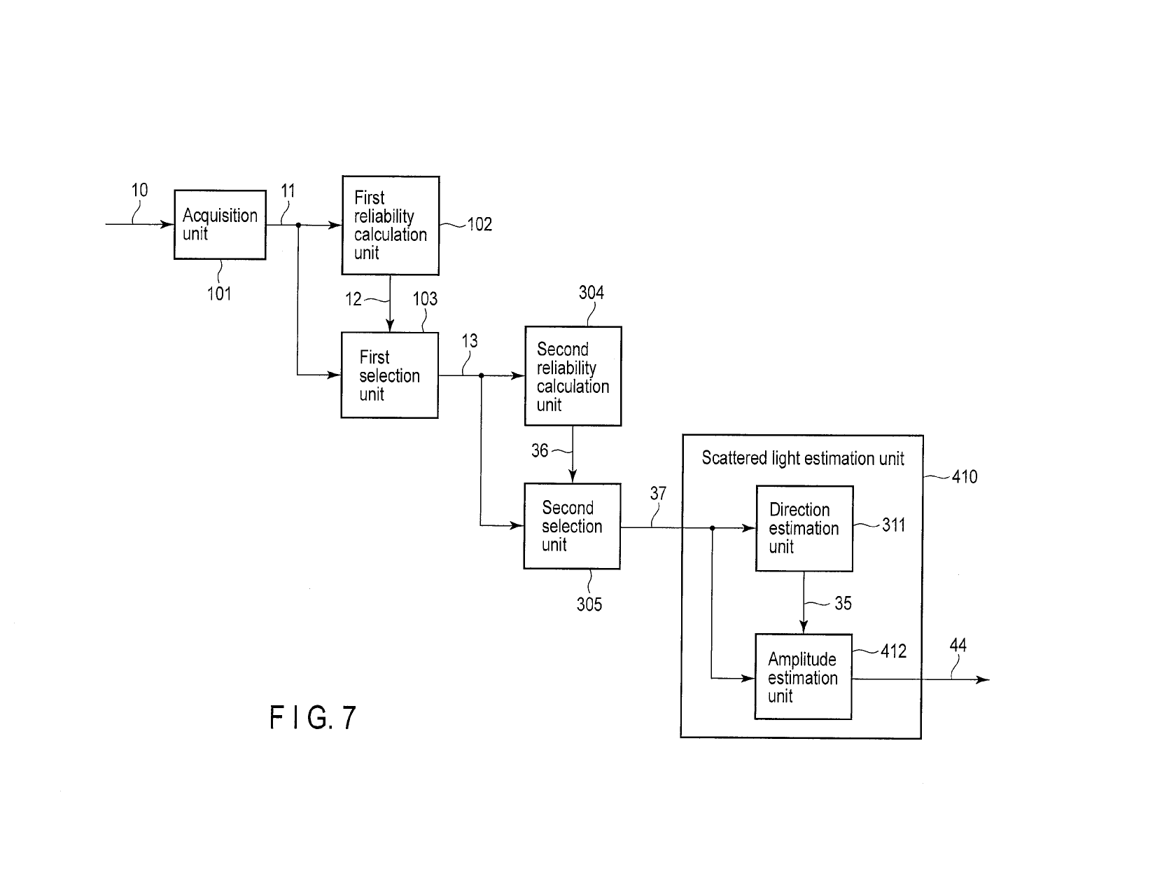

The image processing apparatus according to the third embodiment may be modified, for example, as shown in FIG. 7. An image processing apparatus in FIG. 7 corresponds to the image processing apparatus in FIG. 5 in which the scattered light estimation unit 310 is replaced with a scattered light estimation unit 410. The scattered light estimation unit 410 comprises a direction estimation unit 311 and an amplitude estimation unit 412.

The amplitude estimation unit 412 inputs a plurality of third pixel areas 37 from a second selection unit 305, and also inputs the direction 35 of the scattered light vector from the direction estimation unit 311. The amplitude estimation unit 412 estimates the amplitude of the color of the scattered light based on the direction 35 of the scattered light vector and the plurality of third pixel areas 37. The amplitude estimation unit 412 multiplies the direction 35 of the scattered light vector by the estimated amplitude of the color of the scattered light to obtain the color 44 of the scattered light. The amplitude estimation unit 412 outputs the color 44 of the scattered light. The amplitude estimation unit 412 carries out the same processing as or processing similar to that of the amplitude estimation unit 212 or 312 on the direction 35 of the scattered light vector and the plurality of third pixel areas 37 to estimate the amplitude of the color of the scattered light.

The processing in the above-described embodiments can be implemented using a general-purpose computer as basic hardware. A program implementing the processing in each of the above-described embodiments may be stored in a computer readable storage medium for provision. The program is stored in the storage medium as a file in an installable or executable format. The storage medium is a magnetic disk, an optical disc (CD-ROM, CD-R, DVD, or the like), a magnetooptic disc (MO or the like), a semiconductor memory, or the like. That is, the storage medium may be in any format provided that a program can be stored in the storage medium and that a computer can read the program from the storage medium. Furthermore, the program implementing the processing in each of the above-described embodiments may be stored on a computer (server) connected to a network such as the Internet so as to be downloaded into a computer (client) via the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
an acquisition unit configured to acquire a plurality of first pixel areas from an image;
a first calculation unit configured to calculate a first reliability for each of the plurality of first pixel areas in such a manner that the first reliability increases with increasing at least one of (1) a first evaluation value which increases with increasing planarity, in a color space, of a distribution of pixel values in each of the plurality of first pixel areas, (2) a second evaluation value which increases with increasing wideness of pixel values in each of the plurality of first pixel areas on an estimated plane approximating the distribution of the pixel values in each of the plurality of first pixel areas in the color space, and (3) a third evaluation value which increases with decreasing distance between the estimated plane and an origin of the color space;
a first selection unit configured to select a plurality of second pixel areas from the plurality of first pixel areas based on the first reliability; and
a scattered light estimation unit configured to estimate a color of scattered light in the image based on the plurality of second pixel areas.

2. The apparatus according to claim 1, wherein the scattered light estimation unit comprises:
a direction estimation unit configured to estimate a direction of the scattered light vector in the color space based on the plurality of second pixel areas; and
an amplitude estimation unit configured to estimate an amplitude of the color of the scattered light in the image based on the plurality of second pixel areas and the direction of the scattered light vector.

3. The apparatus according to claim 2, further comprising:
a second calculation unit configured to calculate a second reliability for each of at least one combination comprising at least two of the plurality of second pixel areas in such a manner that the second reliability increases with increasing a sum of levels of orthogonality indicative of angular orthogonality between at least one pair of estimated planes approximating distributions of pixels in the second pixel areas included in the combination; and
a second selection unit configured to select one of the at least one combination based on the second reliability to obtain a plurality of third pixel areas,
wherein the direction estimation unit estimates the direction of the scattered light vector in the color space based on the plurality of third pixel areas.

4. The apparatus according to claim 1, wherein each of the plurality of first pixel areas comprises a pixel of interest and at least one peripheral pixel,
for each of the plurality of first pixel areas, the first calculation unit uses a weight which increases with decreasing difference in color from the pixel of interest to weight the at least one peripheral pixel, and calculates the first reliability based on a weighted distribution of pixel values.

5. The apparatus according to claim 3, wherein each of the plurality of second pixel areas comprises a pixel of interest and at least one peripheral pixel,
for each of the plurality of second pixel areas, the second calculation unit uses a weight which increases with decreasing difference in color from the pixel of interest to weight the at least one peripheral pixel, and calculates the second reliability based on a weighted distribution of pixel values.

6. The apparatus according to claim 1, wherein the scattered light estimation unit uses a weight which increases with increasing the first reliability to weight the plurality of second pixel areas, and estimates the color of the scattered light based on weighted second pixel areas.

7. The apparatus according to claim 2, wherein the direction estimation unit uses a weight which increases with increasing the first reliability to weight the plurality of second pixel areas, and estimates the direction of the scattered light vector based on weighted second pixel areas.

8. The apparatus according to claim 1, wherein the scattered light estimation unit comprises:
a direction estimation unit configured to estimate a predetermined direction to be a direction of the scattered light vector; and
an amplitude estimation unit configured to estimate an amplitude of the color of the scattered light in the image based on the plurality of second pixel areas and the direction of the scattered light vector.

9. The apparatus according to claim 1, wherein the first calculation unit calculates the first reliability for each of the plurality of first pixel areas in such a manner that the first reliability increases with increasing the first evaluation value and the second evaluation value.

10. An image processing method comprising:
acquiring a plurality of first pixel areas from an image;
calculating a first reliability for each of the plurality of first pixel areas in such a manner that the first reliability increases with increasing at least one of (1) a first evaluation value which increases with increasing planarity, in a color space, of a distribution of pixel values in each of the plurality of first pixel areas, (2) a second evaluation value which increases with increasing wideness of pixel values in each of the plurality of first pixel areas on an estimated plane approximating the distribution of the pixel values in each of the plurality of first pixel areas in the color space, and (3) a third evaluation value which increases with decreasing distance between the estimated plane and an origin of the color space;
selecting a plurality of second pixel areas from the plurality of first pixel areas based on the first reliability; and
estimating a color of scattered light in the image based on the plurality of second pixel areas.

11. The method according to claim 10, further comprising:
estimating a direction of the scattered light vector in the color space based on the plurality of second pixel areas; and
estimating an amplitude of the color of the scattered light in the image based on the plurality of second pixel areas and the direction of the scattered light vector.

12. The method according to claim 11, further comprising:
calculating a second reliability for each of at least one combination comprising at least two of the plurality of second pixel areas in such a manner that the second reliability increases with increasing a sum of levels of orthogonality indicative of angular orthogonality between at least one pair of estimated planes approximating distributions of pixels in the second pixel areas included in the combination; and
selecting one of the at least one combination based on the second reliability to obtain a plurality of third pixel areas,
wherein the direction of the scattered light vector in the color space is estimated based on the plurality of third pixel areas.

13. The method according to claim 10, wherein each of the plurality of first pixel areas comprises a pixel of interest and at least one peripheral pixel, and
the method further comprising:
using, for each of the plurality of first pixel areas, a weight which increases with decreasing difference in color from the pixel of interest to weight the at least one peripheral pixel; and
calculating the first reliability based on a weighted distribution of pixel values.

14. The method according to claim 12, wherein each of the plurality of second pixel areas comprises a pixel of interest and at least one peripheral pixel, and
the method further comprising:
using, for each of the plurality of second pixel areas, a weight which increases with decreasing difference in color from the pixel of interest to weight the at least one peripheral pixel; and
calculating the second reliability based on a weighted distribution of pixel values.

15. The method according to claim 10, further comprising:
using a weight which increases with increasing the first reliability to weight the plurality of second pixel areas; and
estimating the color of the scattered light based on weighted second pixel areas.

16. The method according to claim 11, further comprising:
using a weight which increases with increasing the first reliability to weight the plurality of second pixel areas; and
estimating the direction of the scattered light vector based on weighted second pixel areas.

17. The method according to claim 10, further comprising:
estimating a predetermined direction to be a direction of the scattered light vector; and
estimating an amplitude of the color of the scattered light in the image based on the plurality of second pixel areas and the direction of the scattered light vector.

18. The method according to claim 9, wherein the first reliability for each of the plurality of first pixel areas is calculated in such a manner that the first reliability increases with increasing the first evaluation value and the second evaluation value.

19. A non-transitory computer readable storage medium storing instructions of a computer program which when executed by a computer results in performance of steps comprising:
acquiring a plurality of first pixel areas from an image;
calculating a first reliability for each of the plurality of first pixel areas in such a manner that the first reliability increases with increasing at least one of (1) a first evaluation value which increases with increasing planarity, in a color space, of a distribution of pixel values in each of the plurality of first pixel areas, (2) a second evaluation value which increases with increasing wideness of pixel values in each of the plurality of first pixel areas on an estimated plane approximating the distribution of the pixel values in each of the plurality of first pixel areas in the color space, and (3) a third evaluation value which increases with decreasing distance between the estimated plane and an origin of the color space;
selecting a plurality of second pixel areas from the plurality of first pixel areas based on the first reliability; and
estimating a color of scattered light in the image based on the plurality of second pixel areas.
